(19) United States
(12) Patent Application Publication
(10) Pub. No.: US 2006/0238374 A1
(43) Pub. Date: Oct. 26, 2006

(54) Autonomous cleaner

(75) Inventor: Ryo Saeki, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/407,868

(22) Filed: Apr. 19, 2006

(30) Foreign Application Priority Data
Apr. 19, 2005 (JP) 2005-121620

(51) Int. Cl. G08C 19/00

(52) U.S. Cl. 340/825.72; 180/169; 700/258

(57) ABSTRACT

An autonomous cleaner that can be operated with a remote controller without using a dedicated component such as an antenna that receives a signal from the remote controller is provided. The cleaner main body 1 includes eight infrared sensors 11 for detecting obstacles such as furniture. The remote controller 3 outputs an infrared signal corresponding to the pushed key 31. The reflected light from the obstacle and the infrared signal (remote controller signal) from the remote controller are both received at the infrared sensor 11. The light receiving part of the infrared sensor 11 has a function of receiving the signal by the reflected light from the obstacle and receiving the remote controller signal, which signals are identifiable at a micro-computer 22. The cleaner main body 1 can thus be operated with a remote controller 3 using the infrared sensor 11 without arranging a dedicated component such as an antenna.

### BACKGROUND OF THE INVENTION

1. Field of the Invention

The present invention relates to an autonomous cleaner that can be operated with a remote controller.

2. Description of the Related Art

Conventionally, this type of autonomous cleaner (hereinafter referred to as cleaner) rotates the traveling wheels with a motor to move around the room while absorbing dust on the floor by air flow generated by an air blower and collecting the dust in a dust collecting container. An infrared sensor serving as an obstacle sensor for detecting obstacles such as furniture and wall is arranged on the front surface and the like of a main body case of the cleaner (e.g., Japanese Laid-Open Patent Publication No. 2002-360480, paragraphs 0001 to 0007). When the START key of the cleaner is pushed, the cleaner autonomously moves around the room and cleans the entire room according to a predetermined algorithm, avoiding obstacles detected with the infrared sensor. As it is convenient to be able to remotely operate the cleaner, a cleaner that can be operated by a remote controller has been proposed (e.g., Japanese Laid-Open Patent Publication No. 2003-079552, paragraphs 0028, 0031, 0037 to 0039, and FIG. 2). In such cleaner, an antenna is attached upward in a substantially vertical direction to the main body case in a state slightly projected above the height of the main body case in the substantially vertical direction. A wireless communication by an electric wave is performed between the antenna of the cleaner and the antenna of the remote controller.

### SUMMARY OF THE INVENTION

The convenience of the user is enhanced with the cleaners of the prior arts since remote operation is performed with the remote controller. However, the manufacturing cost of the cleaner increases as antenna, electric wave transmitting and receiving circuits and the like become necessary. Further, since the distal end of the antenna projects above the main body case, as mentioned above, the antenna tends to hit the sofa when cleaning under the sofa. The cleanable range thus becomes narrow when attempting to avoid such contact.

The present invention provides, in an aim to solve the above problems, an autonomous cleaner that can be operated with a remote controller without using dedicated components such as an antenna and the like that receives signals from the remote controller.

In the first aspect of the present invention, autonomous cleaner comprising a main body including a suction means for suctioning dust on a cleaning surface, a moving means for moving the main body, an infrared sensor including a light emitting part and a light receiving part for detecting an obstacle, and a controlling means for controlling at least one of the suction means and the moving means based on either an output signal of the light receiving part or a signal transmitted by a remote controller; wherein the remote controller transmits a plurality of the same infrared signals at a predetermined time interval when one operation is performed so that at least one infrared signal is transmitted when the light emitting part is not emitting light; the infrared signal and a reflected light irradiated from the light emitting part and reflected at the obstacle are received by the light receiving part; and the controlling means assumes that the output signal of the light receiving part is from the infrared signal when the output signal of when the light emitting part is emitting light exceeds a threshold value, and again have the light emitting part emit light when assumed that a new infrared signal is not received, and determines that the obstacle is present when the output signal of the light receiving part exceeds the threshold value; receives the infrared signal received at the light receiving part when the light emitting part is not emitting light; and controls at least one of the suction means and the moving means based on the result of determination and reception.

As mentioned above, the light receiving part of the infrared sensor has a function of receiving the reflected light from the obstacle, and a function of receiving the infrared signal from the remote controller. Further, the signal by the reflected light from the obstacle and the infrared signal are identified. Thus, the cleaner main body that moves around while detecting the obstacles with the infrared sensor or the cleaner main body that is stopped can be operated with a remote controller without arranging dedicated components such as an antenna on the cleaner main body and the remote controller. That is, increase in cost of the autonomous cleaner is suppressed even if the cleaner main body is made to be operated by the remote controller. In identification, the controlling means assumes that the output signal is from the infrared signal from the remote controller when the output signal of the light receiving part of when the light emitting part is emitting light exceeds the threshold value and again have the light emitting part emit light when assumed that a new infrared signal is not received, where when such output signal of the light receiving part exceeds the threshold value, determination is made that obstacle is present. The obstacle is reliably detected without being influenced by the infrared signal. When the output signal of the light receiving part of when again having the light emitting part emit light does not exceed the threshold value, the controlling means decides that the infrared signal has exceeded the threshold value the first time and determination is made that obstacle is not present. Further, in identification, the controlling means receives the infrared signal received at the light receiving part when the light emitting part is not emitting light, and thus the infrared signal from the remote controller is reliably received without being influenced by the reflected light from the obstacle.

In the second aspect of the invention, an autonomous cleaner comprising a main body including a suction means for suctioning dust on a cleaning surface, a moving means for moving the main body, an infrared sensor including a light emitting part and a light receiving part for detecting an obstacle, and a controlling means for controlling at least one of the suction means and the moving means based on either an output signal of the light receiving part or a signal transmitted by a remote controller; wherein a signal transmitted by the remote controller is an infrared signal; the infrared signal and a reflected light irradiated from the light emitting part and reflected at the obstacle are received at the light receiving part; and the controlling means identifies the infrared signal and the signal from the reflected light received at the light receiving part, and controls at least one of the suction means and the moving means based on the identified result.

As mentioned above, the light receiving part of the infrared sensor has a function of receiving the reflected light from the obstacle and a function of receiving the infrared signal from the remote controller. Further, the signal by the reflected light from the obstacle and the infrared signal are identified. Thus, the cleaner main body that moves around while detecting the obstacles with the infrared sensor or the cleaner main body that is stopped can be operated with a remote controller without arranging dedicated components such as an antenna on the cleaner main body and the remote controller. That is, increase in cost of the autonomous cleaner is suppressed even if the cleaner main body is made to be operated by the remote controller.

According to the present invention, the cleaner main body that moves around while detecting the obstacles with the infrared sensor or the cleaner main body that is stopped can be operated with a remote controller without arranging dedicated components such as an antenna on the cleaner main body and the remote controller.

### BRIEF DESCRIPTION OF THE DRAWINGS

FIG. 1 is a view showing an autonomous cleaner according to the present invention;

FIG. 2 is a view showing an electrical configuration of the cleaner main body;

FIG. 3 is a view showing an obstacle detection period;

FIG. 4 is a view showing a relationship between the obstacle detection period and a remote controller signal; and

FIG. 5 is a view showing a bit configuration example of the remote controller signal.

### DETAILED DESCRIPTION OF THE PREFERRED EMBODIMENTS

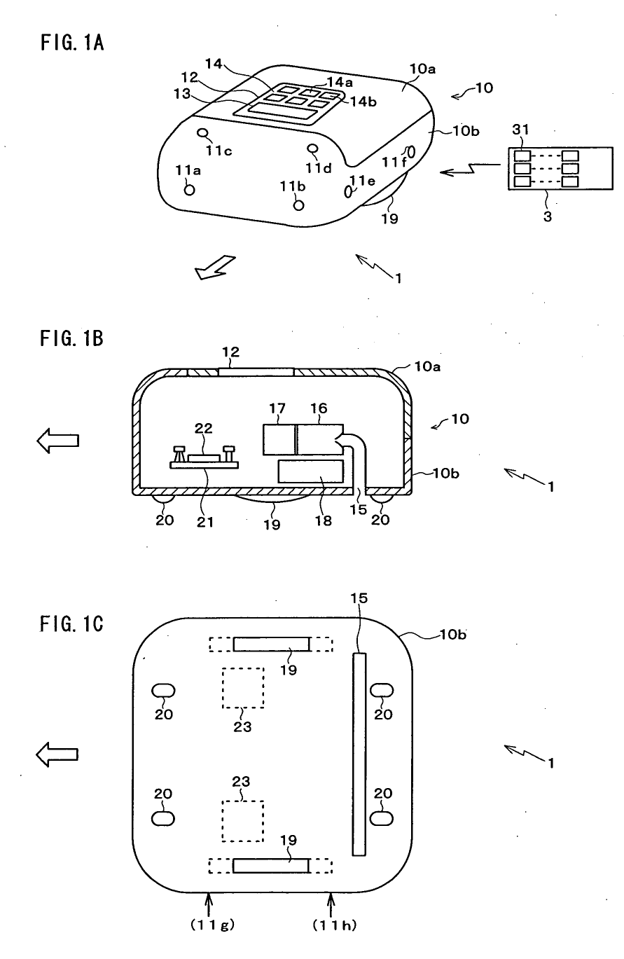

FIG. 1 shows an autonomous cleaner according to the present invention, where FIG. 1A is a perspective view, FIG. 1B is a central longitudinal cross sectional view, and FIG. 1C is a bottom view. The outlined arrow in the figure indicates the direction of movement (forward movement direction) of the cleaner main body 1. This autonomous cleaner is configured by the cleaner main body 1 and a remote controller 3. The cleaner main body 1 includes a hollow main body case 10, which main body case 10 is made up of an openable/closable cover 10a and a housing 10b. A dust collecting container 16 in the main body case 10 can be taken out by opening the cover 10a.

A pair of traveling wheels 19 is arranged to travel (move) the cleaner main body 1, and the left traveling wheel and the right traveling wheel are independently driven with two motors 23 attached to the housing 10b. The motor 23 and the traveling wheels 19 correspond to the moving means of the present invention. The cleaner main body 1 moves forward, moves backward, stops or changes direction by controlling the rotation of the motor 23. The motor 23 and an air blower 17, to be hereinafter described, are supplied with power from a battery 18. The battery 18 is made of a plurality of secondary batteries and charged by a charging circuit (not shown). Further, a pair of spindle shape driven wheels 20 are each arranged on the front side and the back side of the traveling wheels 19, and the weight balance of the main body case 10 is maintained by the driven wheels 20.

An absorbing port 15 is arranged at the bottom surface of the housing 10b, and dust on the floor (cleaning surface) is absorbed from the absorbing port 15 by the air flow generated by the air blower 17 serving as the suction means and collected in the dust collecting container 16. A filter (not shown) through which the air flow passes is attached to the air blower 17 side of the dust collecting container 16. Further, a rotating brush that is rotated by the force of the motor is arranged at the absorbing port 15 to collect dust from the carpet, but the explanation and illustration thereof is omitted since it is not directly relevant to the present invention. An operation panel 12 including a display part 13 and a plurality of keys 14 is arranged on the upper surface of the main body case 10. For instance, the motor 23 and the air blower 17 start to operate when the START key 14a is pushed, whereby cleaning is started; and the motor 23 and the air blower 17 stop when the STOP key 14b is pressed, whereby cleaning is terminated. The operating state of the autonomous cleaner, error message and the like are displayed on the display part 13.

Reflective infrared sensors 11a, 11b for detecting the obstacles at the front, infrared sensors 11c, 11d for detecting the obstacles at the upper front, infrared sensors 11e, 11f for detecting obstacles on the left side, and infrared sensors 11g, 11h (attachment position shown with arrow in FIG. 1C) for detecting obstacles on the right side are respectively attached to the front surface, the distal end part on the upper surface, the left side surface and the right side surface (not shown) of the main body case 10. That is, eight reflective infrared sensors 11 are attached. The infrared sensors 11a to 11d are attached at positions symmetrical with respect to a center line of the main body case 10 in the left and right direction, and the infrared sensors 11e to 11h are attached at positions symmetrical with respect to a center line in the front and back directions.

A remote controller 3 includes a plurality of keys 31. When one of the keys 31 is pushed, an infrared signal (hereinafter referred to as a remote controller infrared signal) corresponding to the pushed key 31 is emitted. In the present embodiment, the same infrared signal is emitted twice at a time at a constant time interval every time the key 31 is pushed. Although it depends on the positional relationship between the remote controller 3 and the eight infrared sensors 11, the infrared signal is received at one of or a plurality of infrared sensors 11. When the infrared sensor 11 receives the remote controller infrared signal, the cleaner main body 1 performs the operation (e.g., start or end of cleaning) corresponding to the pushed key 31.

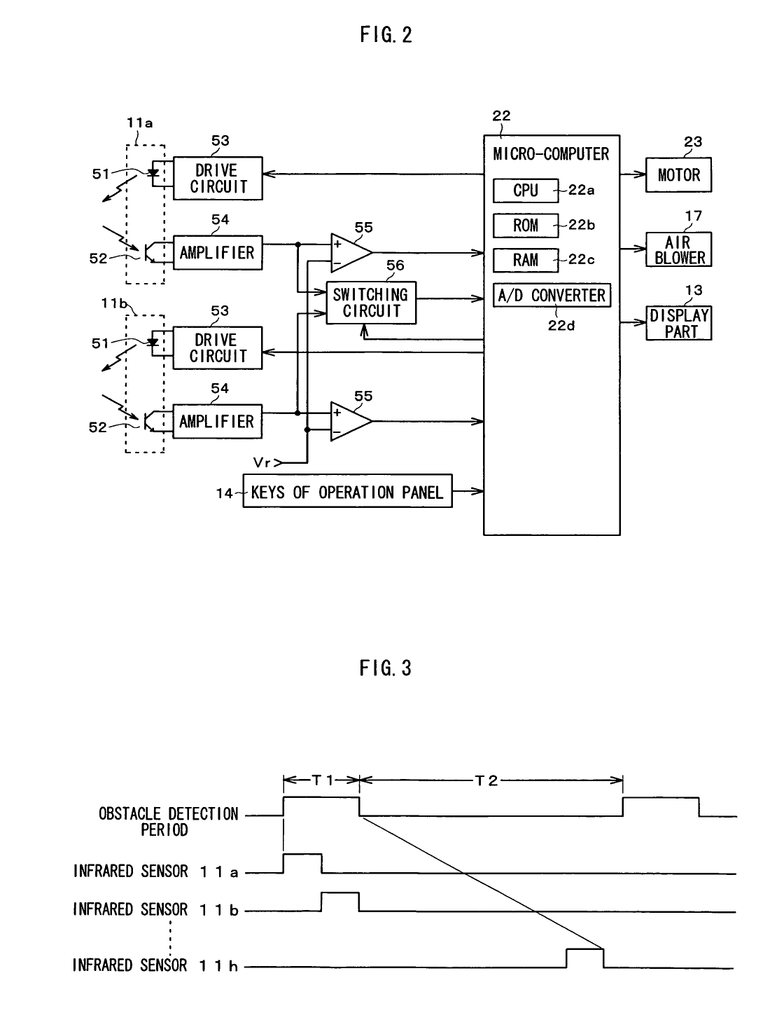

FIG. 2 shows an electrical configuration of the cleaner main body 1. A micro-computer 22 serving as a controlling means is mounted on a printed board 21 (FIG. 1B) along with the peripheral circuits and the like, and includes a CPU 22a, a ROM 22b for storing program, a RAM 22c for storing various data, and A/D converter 22d and the like. The signal from the key 14 of the operation panel 12 and the output signals of the infrared sensors 11a, 11b are input to the micro-computer 22. The signal output from the micro-computer 22 is sent to the drive circuit 53 of the infrared sensor 11, the motor 23, the air blower 17, and the display part 13. The motor 23 and the like are actually driven with a drive circuit (not shown), but the motor 23 and the like are assumed to be controlled/driven by the micro-computer 22 in the following explanation. The micro-computer 22 controls the air blower 17 and the motor 23 according to the signal from the key 14 or the output signal of the infrared sensor 11. The output signal of the infrared sensor 11 includes those related to the reflected light from the obstacle, and those related to the remote controller infrared signal. In the following, the former is referred to as the detected signal, and the latter is referred to as the remote controller signal.

Only the infrared sensors 11a, 11b are shown in FIG. 2, but other infrared sensors 11c to 11h are similarly connected to the micro-computer 22. An LED 51 is a light emitting part for emitting infrared light, and is driven by the drive circuit 53 to which the ON/OFF signal output from the micro-computer 22 is input. A phototransistor 52 is a light receiving part for receiving the reflected light from the obstacles, and the remote controller infrared signal. The output signal of the phototransistor 52 is amplified in an amplifier 54, retrieved into the micro-computer 22 via a switching circuit 56, and further, converted to digital data in an A/D converter 22d. The switching circuit 56 is not necessary if the micro-computer 22 includes eight A/D convertible analog input terminals.

The digital data of when only the reflected light from the obstacle enters the phototransistor 52 is obtained by digitizing the detected signal. When the digital data exceeds a threshold value, that is, when the obstacle is close by, the micro-computer 22 controls the motor 23 to change the direction of the moving cleaner main body 1. The output signal of the amplifier 54 is input to the positive terminal of a comparator 55, and a predetermined threshold voltage Vr is input to a negative terminal. The output signal of the comparator 55 of when only the remote controller infrared signal enters the phototransistor 52 is a signal obtained by binarizing the remote controller signal. The output signal of the comparator 55 is input to the micro-computer 22, and interruption occurs in the CPU 22a at the rise and decay of the signal. The remote controller signal is analyzed by the interruption handling program.

FIG. 3 shows an obstacle detection period. The obstacle detection period is a period in which the infrared sensor 11 is activated to detect the obstacle. When the cleaner main body 1 is cleaning, that is, moving, the obstacle detection period and a pause period in which the infrared sensor 11 is not activated are alternately repeated. T1 is a time for the obstacle detection period and T2 is a time for the pause period. During the obstacle detection period, the micro-computer 22 activates the infrared sensors 11a to 11h in the order shown in the figure. For instance, when activating the infrared sensor 11a, the micro-computer 22 has only the LED 51 of the infrared sensor 11a emit light and A/D converts the output signal of the phototransistor 52 of the infrared sensor 11a selected at the switching circuit 56.

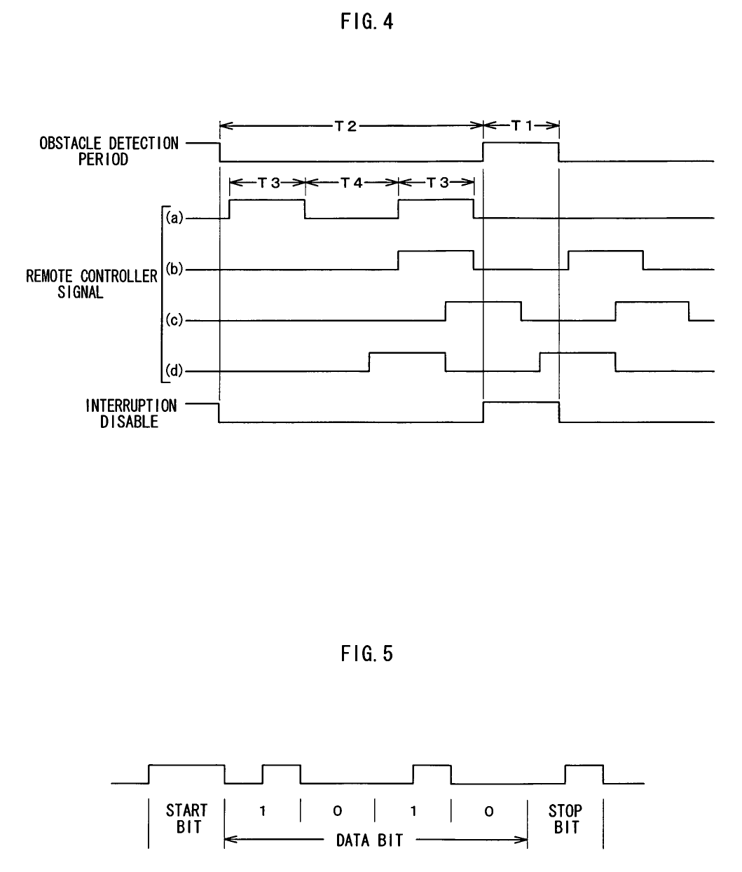

FIG. 4 shows a relationship between the obstacle detection period and the remote controller signal. T3 is a time width of the remote controller signal, and T4 is a time interval between the first and second remote controller signals. The following relationship expressed in equations (1) and (2) are given for T1 to T4, where T1 is 16 ms, T2 is 52 ms, T3 is 16 ms, T4 is 18 ms, for example.
T1<T4 (1)
T2>2·T3+T4 (2)

T1 to T4 are determined taking into consideration the movement speed and the like of the cleaner main body 1 so that detection delay of the obstacle does not occur. Therefore, the relationship between the obstacle detection period and the remote controller signal becomes one of (a) to (d) in the figure. Further, the micro-computer 22 (CPU 22a) is set to an interruption disable state during the obstacle detection period. That is, interruption does not occur in the detected signal. Interruption also does not occur at the rise and decay of the remote controller signal received during the obstacle detection period.

FIG. 5 shows a bit configuration example of the remote controller signal. This signal is a signal of six bits, and configured by a head start bit, followed by four bits of data bit, and a final stop bit. The start bit has the entire bit width at high. The stop bit has only the last half of the bit width at high. The data bit “1” has only the last half of the bit width at high, and the data bit “0” has the entire bit width at low.

The detection of the obstacle will now be explained. Since the remote controller 3 is operated by a person, the object detection period and the remote controller signal are not synchronized, as shown in FIG. 4. For instance, as shown in FIG. 4(c), the phototransistor 52 of the infrared sensor 11a may receive the remote controller infrared signal when the LED 51 of the infrared sensor 11a is emitting light. Here, if the obstacle is at the front of the infrared sensor 11a, the detected signal and the remote controller signal are mixed in the output signal of the amplifier 54. The micro-computer 22 cannot decide whether only one of or both the detected signal and the remote controller signal have been A/D converted.

Thus, the micro-computer stops or decelerates the cleaner main body 1 when the value of the A/D converted digital data exceeds the threshold value. For instance, when the time has elapsed for T2/2, that is, when the next (new) remote controller signal is assumed to be not present assuming that the value of the digital data exceeds the threshold value by the remote controller signal, the LED 51 of the infrared sensor 11a emits light, and the digital data at such point is obtained. If the value of the digital data also exceeds the threshold value, the micro-computer 22 determines that there is obstacle and changes the direction of the cleaner main body 1 and starts the movement, and if the value does not exceed the threshold value, the micro-computer 22 determines that there is no obstacle and again starts the movement. The remote controller is configured so as not to output the next infrared signal until a time of 2·T2 has elapsed after two infrared signals have been output.

Next, the reception of the remote controller signal will be explained. The micro-computer 22 receives the remote controller signal in the following manner by the program of the ROM. Cases of FIG. 4(a), (b) will first be explained. As described above, interruption occurs at the rise/decay of the output signal of the comparator 55, that is, the remote controller signal, and the remote controller signal is received while checking the bit width of the start bit, the bit width of the stop bit, decay timing of stop bit and the like by the interruption handling program. Here, the first and the second remote controller signals do not interfere with the reflected light from the obstacle and are both properly received. However, since the remote controller signal received after T2 has elapsed from when the first remote controller signal is received is ignored by the micro-computer 22, control of the motor 23, the air blower 17 and the like is performed based on the data bit of the first remote controller signal.

A case of FIG. 4(c) will now be explained. Since the micro-computer 22 is in the interruption disable state at the decay of the stop bit of the first remote controller signal and the stop bit is not detected, such remote controller signal is not received. The second remote controller signal is properly received. A case of FIG. 4(d) will now be explained. The first remote controller signal is properly received. Since the micro-computer 22 is in the interruption disable state at the rise of the start bit of the second remote controller signal and the start bit is not detected, such remote controller signal is not received. When the remote controller signal is simultaneously received at a plurality of infrared sensors 11, for example, the infrared sensors 11a and 11b, one of the remote controller signals properly received is used as the control signal. The above explanation is based on the fact that the cleaner main body 1 moves around while emitting LED 51, but when the cleaner main body is stopped, the reception of the remote controller signal becomes easy since the LED 51 does not emit light.

As described above, the phototransistor 52 serving as the light receiving part of the infrared sensor 11 has both the function of receiving the reflected light from the obstacle and the function of receiving the remote controller infrared signal. Further, the detected signal related to the reflected light from the obstacle and the remote controller signal related to the remote controller infrared signal are identified by the above described control of the micro-computer 22. Thus, it is possible to operate the cleaner main body 1, which either moves around while detecting the obstacles with the infrared sensor 11 or stops, from the remote controller 3 without providing the cleaner main body 1 and the remote controller 3 with an exclusive component such as an antenna.

Although two remote controller infrared signals are output when the key 31 of the remote controller 3 is pushed in the above described embodiment, the present invention may be performed even if three or more signals are output. In the above embodiment, the interruption disabling process is adopted so as to receive the remote controller signal without being influenced by the reflected light from the obstacle, but other methods may be used. Further, the infrared sensor 11 is used for all the obstacle sensors in the above embodiment, but other sensors such as an ultrasonic sensor may be used for a part of the obstacle sensors.

What is claimed is:

1. An autonomous cleaner comprising:
a main body including a suction means for suctioning dust on a cleaning surface;
a moving means for moving the main body;
an infrared sensor including a light emitting part and a light receiving part for detecting an obstacle; and
a controlling means for controlling at least one of the suction means and the moving means based on either an output signal of the light receiving part or a signal transmitted by a remote controller, wherein
the remote controller transmits a plurality of the same infrared signals at a predetermined time interval when one operation is performed so that at least one infrared signal is transmitted when the light emitting part is not emitting light,
the infrared signal and a reflected light irradiated from the light emitting part and reflected at the obstacle are received by the light receiving part, and
the controlling means:
assumes that the output signal of the light receiving part is from the infrared signal when the output signal of when the light emitting part is emitting light exceeds a threshold value, and again have the light emitting part emit light when assumed that a new infrared signal is not received, and determines that the obstacle is present when the output signal of the light receiving part exceeds the threshold value;
receives the infrared signal received at the light receiving part when the light emitting part is not emitting light; and
controls at least one of the suction means and the moving means based on the result of determination and reception.

2. An autonomous cleaner comprising:
a main body including a suction means for suctioning dust on a cleaning surface;
a moving means for moving the main body;
an infrared sensor including a light emitting part and a light receiving part for detecting an obstacle; and
a controlling means for controlling at least one of the suction means and the moving means based on either an output signal of the light receiving part or a signal transmitted by a remote controller, wherein
a signal transmitted by the remote controller is an infrared signal,
the infrared signal and a reflected light irradiated from the light emitting part and reflected at the obstacle are received at the light receiving part, and
the controlling means identifies the infrared signal and the signal from the reflected light received at the light receiving part, and controls at least one of the suction means and the moving means based on the identified result.
